(19) United States
(12) Patent Application Publication
(10) Pub. No.: US 2024/0190676 A1
(43) Pub. Date: Jun. 13, 2024

(54) Buffer system and method for buffering a length of a strip between an input side and an output side, and related computer program product

(71) Applicant: VMI Holland B.V., EPE (NL)

(72) Inventors: Willem Marinus VAN BEEK, EPE (NL); Robin NUSSELDER, EPE (NL)

(21) Appl. No.: 18/285,350

(22) PCT Filed: Mar. 18, 2022
(86) PCT No.: PCT/NL2022/050145

§ 371 Date: Oct. 2, 2023

(30) Foreign Application Priority Data
Apr. 1, 2021 (NL) 2027902

(51) Int. Cl. B65H 20/34; B29C 48/00; B29C 48/07; B29C 48/25; B29C 48/355; B29C 48/92; B29D 30/00; B65H 23/04; B65H 23/26; B65H 43/00

(52) U.S. Cl. CPC B65H 20/34; B29C 48/0022; B29C 48/252; B29C 48/355; B29C 48/92; B65H 23/044; B65H 23/048; B65H 23/26; B65H 43/00; B29C 48/07; B29D 30/0016; B29D 2030/0038; B65H 2408/2171; B65H 2557/24; B65H 2701/11332; B65H 2801/93

(57) ABSTRACT

Disclosed is a buffer system for buffering a length of a strip, wherein the buffer system includes a buffer member, a buffer drive and a control unit, wherein the control unit is configured for receiving control data having information indicative of an input amount of the strip at the input side and information indicative of an output amount of the strip at the output side, and for generating, based on said control data, a computed value indicative of a theoretical length of the strip in the buffer system between the input side and the output side, wherein the control unit is further configured for positioning the buffer member at a buffer position based on the computed value. The disclosure also provides a method for buffering a length of a strip, and a computer program product.

### BACKGROUND

The invention relates to a buffer system and a method for buffering a length of a strip between an input side and an output side. The invention further relates to the computer program product that, when executed, causes the buffer system to perform the aforementioned method.

In the technical field of tire building, it is known to provide a buffer system between a continuous input, i.e. an extruder, and a discontinuous output, i.e. a cutting station, to buffer a variable length of strip. The known buffer system comprises a dancer roller and/or a festooner. Both are capable of varying the buffer capacity of the buffer system. The buffer system may respond passively to changes in tension in the strip, i.e. by providing a counterweight to the aforementioned dancer roller or festooner, or the buffer system may be controlled actively based on strip parameters such as strip tension.

### SUMMARY OF THE INVENTION

In pursuit of reducing cycle times at the discontinuous output, the strip is accelerated and decelerated increasingly faster. A disadvantage of the known, passive buffer systems is that the inertia of the counterweight with higher acceleration and deceleration is difficult to overcome. A disadvantage of the known, actively controlled buffer systems is that there is the measured strip tension is not necessarily indicative of the amount of strip that is buffered in the buffer system. In particular, the material of the strip tends to relax over time, thus reducing the strip tension. Moreover, during the buffering process, acceleration and deceleration may cause small variations in tension. The known buffer system will respond accordingly and adjust the buffer capacity, causing unwarranted stretching or compression of the strip, and consequently variations in the cross-sectional shape of the strip.

It is an object of the present invention to provide a buffer system and a method for buffering a length of a strip between an input side and an output side, and to the related computer program product, wherein the buffering of the strip can be improved.

According to first aspect, the invention provides a buffer system for buffering a length of a strip between an input side and an output side, wherein the buffer system comprises a buffer member that is movable in a buffer direction along a range of buffer positions to vary a buffer capacity of the buffer system, a buffer drive for moving the buffer member in said buffer direction and a control unit that is operationally connected to the buffer drive, wherein the control unit is configured for receiving control data having information indicative of an input amount of the strip at the input side and information indicative of an output amount of the strip at the output side, and for generating, based on said control data, a computed value indicative of a theoretical length of the strip in the buffer system between the input side and the output side, wherein the control unit is further configured for controlling the buffer drive to position the buffer member at one buffer position from the range of buffer positions based on the computed value.

The buffer system according to the present invention can thus be controlled based on the amount of strip in the buffer system, i.e. the length of the strip between the input side and the output side. In particular, the input amount may expressed as the amount of travel of the strip into the buffer system at the input side and the output amount may be expressed as the amount of travel of the strip out of the buffer system at the output side. Alternatively, the position of one or more sections of the strip within the buffer system may be tracked.

By having a travel-based or position-based movement control rather than a tension-based movement control, the buffer system can function independently of the tension in the strip and/or independently of time. In particular, it can be prevented that the buffer system changes the buffer capacity solely based on tension. More in particular, regardless of any changes in tension, if the amount of strip material in the buffer remains the same, there is actually no need to adjust the buffer capacity. Hence, variable tensions in the strip, i.e. as a result of relaxation over time, do not influence the travel-based control. As a result, the strip is not stretched or compressed unnecessarily and the cross sectional shape of the strip can be kept more uniform. Advantageously, the system can operate with very low tension in the strip, or without any tension at all, i.e. with the strip loosely extending along the buffer member.

Preferably, every meter of the strip entering the buffer system at the input side can ultimately exit the buffer system at the output side still having the same or substantially the same length and/or a constant or substantially constant cross-sectional shape. Alternatively, every meter of the strip entering the buffer system at the input side can ultimately exit the buffer system at the output side having a slightly stretched length, in a constant relationship to the length of the same section of the strip at the input side. The stretching can prevent slacking of the strip in the buffer system.

Preferably, the buffer system further comprises a (non-transitory) memory unit that is operationally connected to the control unit, wherein the memory unit stores a theoretical model of the buffer system, wherein the theoretical model, when executed by the control unit, is configured for outputting the computed value as a function of the control data. By providing a memory unit with instructions that, when executed, define a theoretical model of the buffer system, the buffer system can be operated as a black-box that only requires the input amount and the output amount to determine the computed value indicative of the theoretical length.

In one embodiment, the computed value is the theoretical length of the strip. Hence, the buffer position can be controlled as a direct function of the theoretical length.

Alternatively, the memory unit is configured for storing a reference value for the theoretical length of the strip, wherein the computed value is (indicative of) an effect of the control data on the reference value. The theoretical length can be determined as the sum of the reference value and the effect of the control data on the reference value. For example, if the effect of the control data on the reference value is minus one meter, then the theoretical length will be the reference value minus said one meter. The buffer position can be controlled as a function of the effect, or as a function of theoretical length after taking into account said effect on the reference value.

In a preferred embodiment thereof, the control unit is arranged for executing the theoretical model in cycles, wherein the reference value is defined at the start of the first cycle and remains the same during the subsequent cycles, wherein the computed value is the cumulative effect of the control data on the reference value after each cycle. In this case, the theoretical length can be determined as the sum of the reference value and the cumulative effect of the control data on the reference value. Alternatively, for each subsequent cycle the reference value is the sum of the reference value of the previous cycle and the effect of the control data on said reference value. In this case, the theoretical length can be determined as the sum of the reference value and the effect of the control data on the reference value.

In a further embodiment the theoretical model, when executed by the control unit, is further configured for outputting a position value indicative of said one buffer position from the range of buffer positions that provides the buffer capacity to match the theoretical length of the strip, wherein the control unit is configured for controlling the buffer drive to position the buffer member at said one buffer position corresponding to said position value. Instead of looking-up a position value in a table, the position value can be calculated continuously or at certain intervals for any theoretical length of the strip.

Alternatively, the memory unit stores a list of position values indicative of the range of buffer positions cross-referenced with a list of predetermined values indicative of the buffer capacity of the buffer system at the respective buffer positions, wherein the control unit is configured for selecting one position value from the list of position values based on the predetermined value from the list of predetermined values that best matches the theoretical length of the strip, wherein the control unit is configured for controlling the buffer drive to position the buffer member at said one buffer position corresponding to said one position value. The predetermined values can be experimentally determined or measured during the setup of the buffer system. Provided that a sufficient number of predetermined values is provided, the movement control can approximate a continuous movement control as described in the previous embodiment.

In another the embodiment buffer capacity corresponding to the one buffer position is smaller than the theoretical length of the strip indicated by the computed value on which said one buffer position is based. Hence, the strip can be stretched slightly to prevent slacking of the strip in the buffer system. Preferably, the amount of stretching is kept constant or substantially constant.

In another embodiment the input amount is the distance of travel of the strip at the input side and wherein the output amount is the distance of travel of the strip at the output side. The amount of travel at the input side and the output side, for example expressed in units of length of the strip that enter and/or exit the buffer system, can be used to determine the net difference between the input and output. This can be used to directly control the buffer position and/or to determine the theoretical length for a subsequent control of the buffer position based on said theoretical length.

In another embodiment the buffer system comprises one or more sensors that are operationally connected to the control unit for providing the information indicative of the input amount and/or the information indicative of the output amount to the control unit. The one or more sensor may for example comprise an encoder, an optical sensor or the like for measuring a parameter directly related to or indicative of the speed at the input side and/or the output side. An encoder can accurately provide a pulse to the control unit for each unit of travel of the strip.

Additionally or alternatively, the information indicative input amount and/or the information indicative of the output amount comprises one or more control parameters originating from one or more stations upstream or downstream of the buffer system. The one or more control parameters may for example comprise drive parameters of an upstream downstream conveyor, drive parameters of a downstream festooner, extruder parameters of an upstream extruder or cutting parameters of a downstream cutting station. These parameters may be indirectly related to or indicative of the speed at the input side and/or the output side.

In a further embodiment the buffer member is a dancer roller. The dancer roller can buffer a relatively short length of the strip in a single loop in comparison to, for example, multiple loops in a festooner.

Alternatively, the buffer system comprises a festooner with a first holder and a second holder for holding a first group of festooner rollers and a second group of festooner rollers, wherein the buffer member is one of the first holder and the second holder. In contrast to the single loop of the dancer roller, the festooner can buffer a considerable length of the strip in a plurality of loops extending alternately between a festooner roller at the first holder and a festooner roller at the second holder.

In another embodiment the buffer drive comprises a servo motor. The servo motor can act directly on the buffer member to move said buffer member linearly in the buffer direction along the range of buffer positions.

In another embodiment the buffer system further comprises a tension sensor for sensing tension in the strip. Signals from the tension sensor can be used to further adjust the position of the buffer member relative to said one buffer position of the plurality of buffer positions to cancel out unwanted variations in tension, to prevent the build-up of tension over several feeding cycles or to reduce tension in the strip prior to or during a subsequent cutting operation.

In another embodiment the buffer system further comprises an infeed roller for feeding the strip to the buffer member and a slacking section between the infeed roller and the buffer member for receiving a free loop of the strip. Hence any remaining tension in the strip can be at least partially cancelled out or absorbed in the free loop of the strip in the slacking section.

According to a second aspect, the invention provides a method for buffering a length of a strip between an input side and an output side of a buffer system, wherein the buffer system comprises a buffer member that is movable in a buffer direction along a range of buffer positions to vary a buffer capacity of the buffer system, wherein the method comprises the steps of:
collecting control data having information indicative of an input amount of the strip at the input side and information indicative of an output amount of the strip at the output side;
generating a computed value indicative of a theoretical length of the strip in the buffer system between the input side and the output side based on said control data; and
positioning the buffer member at one buffer position from the range of buffer positions based on the computed value.

The method according to the second aspect of the invention relates to the same operational principle as described in relation to the buffer system according to the first aspect of the invention, and thus has the same technical advantages that will not be repeated hereafter.

Preferably, the method further comprises the steps of:
providing a theoretical model of the buffer system; and
executing the theoretical model;
wherein the theoretical model outputs the computed value as a function of the control data.

In one embodiment computed value is the theoretical length of the strip.

Alternatively, the method further comprises the step of:
storing a reference value for the theoretical length of the strip;
wherein the computed value is the effect of the control data on the reference value.

In a preferred embodiment thereof the method comprises the steps of:
executing the theoretical model in cycles;
defining the reference value at the start of the first cycle;
wherein the reference value remains the same during the subsequent cycles, wherein the computed value is the cumulative effect of the control data on the reference value after each cycle. Alternatively, for each subsequent cycle the reference value is the sum of the reference value of the previous cycle and the effect of the control data on said reference value.

In a further embodiment the theoretical model, when executed, outputs a position value indicative of said one buffer position from the range of buffer positions that provides the buffer capacity to match the theoretical length of the strip, wherein the method comprises the step of positioning the buffer member at said one buffer position corresponding to said position value.

Alternatively, the method further comprises the steps of:
storing a list of position values indicative of the range of buffer positions cross-referenced with a list of predetermined values indicative of the buffer capacity of the buffer system at the respective buffer positions; and
selecting one position value from the list of position values based on the predetermined value from the list of predetermined values that best matches the theoretical length of the strip;
wherein the buffer member is positioned at said one buffer position corresponding to said one position value.

In another embodiment the buffer capacity corresponding to the one buffer position is smaller than the theoretical length of the strip indicated by the computed value on which said one buffer position is based.

In another embodiment the buffer system comprises one or more sensors for providing the information indicative of the input amount and/or the information indicative of the output amount.

In another embodiment the input amount is the distance of travel of the strip at the input side and wherein the output amount is the distance of travel of the strip at the output side.

In another embodiment the information indicative of the input amount and/or the information indicative of the output amount comprises one or more control parameters originating from one or more stations upstream or downstream of the buffer system.

In a further embodiment the buffer member is a dancer roller.

Alternatively, the buffer system comprises a festooner with a first holder and a second holder for holding a first group of festooner rollers and a second group of festooner rollers, wherein the buffer member is one of the first holder and the second holder.

In a further embodiment the method further comprises the steps of:
sensing tension in the strip; and
adjusting the position of the buffer member relative to said one buffer position from the range of buffer positions based on the tension in the strip.

In a another embodiment the buffer system further comprises an infeed roller for feeding the strip to the buffer member and a slacking section between the infeed roller and the buffer member, wherein the method further comprises the step of receiving a free loop of the strip in said slacking section.

According to a third aspect, the invention provides a computer-implemented invention, a (non-transitory) computer-readable medium, a computer-readable data carrier or a computer program product comprising instructions that, when executed by a processor, cause the buffer system according to the first aspect of the invention to perform the steps of the method according to the second aspect of the invention.

The computer program product may be provided and/or sold separately from the buffer system, i.e. in the form of software that can be installed on or via the control unit.

According to a fourth, unclaimed aspect, the invention provides a buffer system for buffering a length of a strip between an input side and an output side, wherein the buffer system comprises a dancer roller that is movable in a buffer direction along a range of buffer positions to vary a buffer capacity of the buffer system and a servo motor for moving the buffer member in said buffer direction. The servo motor can act directly on the buffer member to move said buffer member linearly in the buffer direction along the range of buffer positions. Moreover, the servo motor does not require a counterweight and thus has considerably less inertia to overcome. Finally, the gravitational force generated by the weight of the buffer member can be used in downward strokes to further add to the driving forces. Consequently, the servo-controlled buffer member can accelerate and decelerate much more quickly than the conventional counterweight operated dancer roller.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1 and 2 show front views of a buffer system comprising a dancer roller according to a first embodiment of the invention, with the dancer roller in a first buffer position and a second buffer position, respectively;

FIGS. 3 and 4 show front views of an alternative buffer system comprising a festooner according to a second embodiment of the invention, with the festooner in a first state and a second state, respectively;

FIG. 5 shows a front view of a control unit and a memory unit for controlling the buffer system according to FIGS. 1 and 2;

FIG. 6 shows a detail of a front view of a further alternative buffer system according to a third embodiment of the invention; and

FIG. 7 shows a front view of a further alternative buffer system according to a fourth embodiment of the invention.

### DETAILED DESCRIPTION OF THE INVENTION

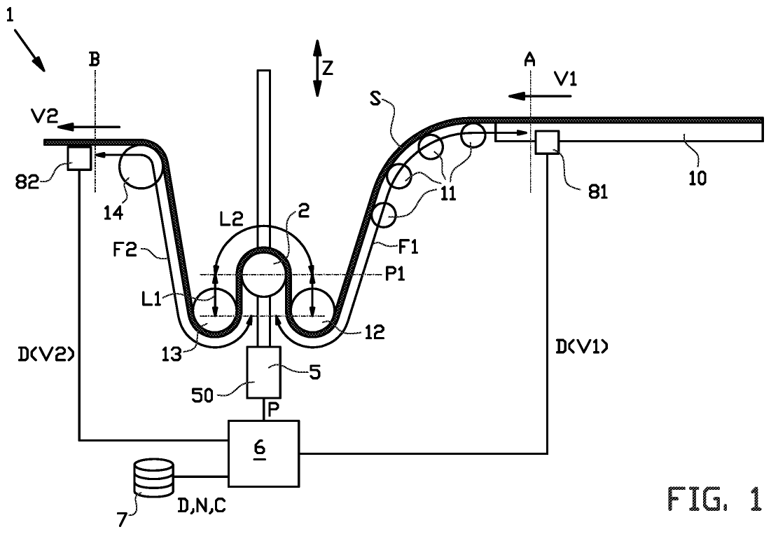

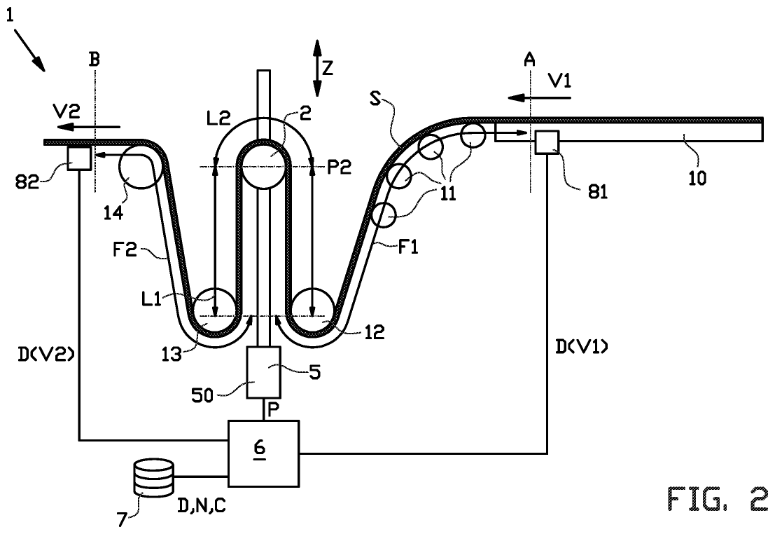

FIGS. 1 and 2 show a buffer system 1 according to a first exemplary embodiment of the invention, for buffering a length of a strip S between an input side A and an output side B of said buffer system 1. In this specific example, the strip S is an apex or apex filler strip. Such a strip S is ultimately combined with a bead to form a bead-apex assembly, to be used in tire building. The strip S is typically extruded by an extruder upstream of the buffer system 1 and cut to length in a cutting station downstream of said buffer system 1. The extruder is configured for supplying the strip S at a substantially continuous rate, whereas the strip S repeatedly comes to a hold in the cutting station for accurate cutting. Hence, the input of the buffer system 1 is substantially continuous and/or constant while the output is discontinuous and/or start-stop. The buffer system 1 is arranged for buffering a variable length of the strip S between said continuous input and discontinuous output.

As shown in FIGS. 1 and 2, the buffer system 1 comprises a buffer member 2 that is movable in a buffer direction Z along a range of buffer positions P1, P2, in particular a first buffer position P1, as shown in FIG. 1, and a second buffer position P2, as shown in FIG. 2. The buffer member 2 is preferably steplessly positionable at any buffer position between the buffer positions P1, P2 as shown. In this example, the buffer direction Z is vertical or substantially vertical. It will be appreciated that at every buffer position P1, P2 from the range of buffer position P1, P2, the buffer member 2 defines a different buffer capacity of the buffer system 1.

In this exemplary embodiment, the buffer member 2 is a dancer roller 2. The dancer roller 2 may be rotated passively or its rotation may be actively controlled to match the speed of the strip S at the dancer roller 2.

The buffer system 1 further comprises a buffer drive 5 for moving the buffer member 2 in the buffer direction Z. In this example, the buffer drive 5 is or comprises a servo motor 50. The servo motor 50 is arranged for linearly driving the movement of the buffer member 2 in the buffer direction Z. In particular, the servo motor 50 engages directly onto the buffer member 2.

The buffer system 1 further comprises a supply conveyor 10 and one or more infeed rollers 11, 12 directly downstream of said supply conveyor 10 for feeding the strip S towards the buffer member 2 at the input side A at an input amount V1, for example expressed in the amount of meters of the strip S that travel into the buffer system 1 at the input side A. The buffer system 1 further comprises one or more outfeed rollers 13, 14 for feeding the strip S away from the dancer roller 2 at the output side B at an output output V2, for example also expressed in the amount of meters of the strip S that travel out of the buffer system 1 at the output side B. The positions of the input conveyor 10, the one or more infeed rollers 11, 12 and the one or more outfeed rollers 13, 14 are fixed.

The strip S travels a path through the buffer system 1 between the input side A and the output side B that has a theoretical length L defined by the relatively positions of the components of the buffer system 1 between the input side A and the output side B, the input amount V1 of the strip S at the input side A and the output amount V2 of the strip S at the output side B. All depends on where one puts the input side A and the output side B. In this example, the input side A is located at the end of the supply conveyor 10, upstream of the one or more input rollers 11, 12, and the output side B is located downstream of the one or more output rollers 13, 14. Alternatively, the input side A and the output side B can be located further upstream or downstream. The path should however at least include the section of the theoretical length L that is variable as a result of the movement of the buffer member 2 in the buffer direction Z.

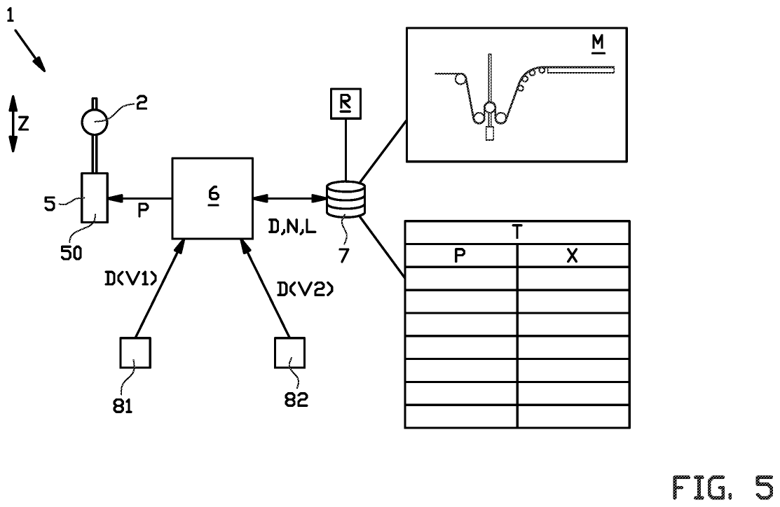

The theoretical length L can be defined theoretically, i.e. with a theoretical model M of the buffer system 1, as shown in FIG. 5. The theoretical model may be a graphical representation of the buffer system 1, a computer simulation, one or more formulas or a combination thereof. In this case, the theoretical model comprises a formula to calculate the theoretical length L as the sum of the fixed length travelled by the strip S along the one or more infeed rollers 11, 12, hereafter referred to as ‘the input length F1’, the fixed length travelled by the strip S along the one or more outfeed rollers 13, 14, hereafter referred to as ‘the output length F2’ and the variable length L1, L2 travelled by the strip S between the one or more infeed rollers 11, 12 and the one or more outfeed rollers 13, 14, i.e. along the buffer member 2.

Hence, in this particular example, the formula for the theoretical length L of the strip S becomes:

L=F1+L1+L2+L1+F2

As the input length F1 and the output length F2 are fixed, they can be predetermined.

The variable length L1, L2 may comprise a number of parameters, in this case:
a first buffer length section L1 defined by the distance of the buffer position P1, P2 of the buffer member 2 relative to the input roller 12 directly upstream of the buffer member 2 and the output roller 13 directly downstream of the buffer member 2; and
a second buffer length section L2 defined by a fixed arc length travelled by the strip S along the buffer member 2.

In this example, the arc is substantially semicircular and thus has a fixed arc length. Hence, the second buffer length section L2 can be determined as:

L2=π·radius

wherein ‘radius’ is the radius of the buffer member 2.

The first buffer length section L1 is the only variable part of the theoretical length and is dependent on the cumulative effect ΣE of changes in the input amount V1 of the strip S at the input side A and the output amount V2 of the strip S at the output side B on a reference value R, for example the theoretical length L of the strip S at the start of the buffering. The cumulative effect EE is divided over two instances of the first buffer length section L1. Therefore, the first buffer length section L1 can be determined as:

$$L 1 = R - ( F 1 + L 2 + F 2 ) + \frac{\sum E}{2}$$

wherein R is the reference value and ΣE is the cumulative effect of the changes in the input amount V1 and the output amount V2 on the reference value R.

Alternatively, the reference value R can be updated after every cycle to match the most recently calculated theoretical length L, in which case the effect E of changes in the input amount V1 of the strip S at the input side A and the output amount V2 of the strip S at the output side B on the reference value R in the formulas above does not need to be cumulative.

It will be appreciated by one skilled in the art that the buffer system 1 may be subject to many variations in configuration, relative positioning and number of components, each of which will result in theoretical model different to the previously discussed theoretical model M. The theoretical model M is merely included to illustrate the operation of one exemplary embodiment and is not meant to limit the scope of the invention in any way.

As schematically shown in FIG. 5, the buffer system 1 comprises a control unit 6, i.e. a processor, that is operationally and/or electronically connected to the buffer drive 5 for controlling the movement of the buffer member 2. The buffer system 1 is further provided with a memory unit 7 that is operationally and/or electronically connected to the control unit 6. The memory unit 7 can store the theoretical model M of the buffer system 1 so that it can be loaded, processed and/or executed by the control unit 6.

As shown in FIGS. 1 and 2, the buffer system 1 is further provided with one or more sensors 81, 82 that are operationally and/or electronically connected to the control unit 6. In this example, the one or more sensors 81, 82 comprises a first sensor 81 that is located at or near the input side A of the buffer system 1 to measure or detect the input amount V1 of the strip S at or near said input side A and a second sensor 82 that is located at or near the output side B of the buffer system 1 to measure or detect the output amount V2 of the strip S at or near said output side B. The first sensor 81 may for example be an encoder coupled with the supply conveyor 10 or one of the one or more input rollers 11, 12. The second sensor 82 may for example be an encoder coupled with one of the one or more output rollers 13, 14. The encoders can accurately detect the amount of travel of the strip S into and out of the buffer system 1, i.e. in the form of a pulse for each unit of travel.

Alternatively, the first sensor 81 and/or the second sensor 82 may be any other type of sensor suitable for detecting a parameter indicative of the input amount V1 and/or the output amount V2, i.e. an optical sensor or wheel rolling over the strip S. In a further alternative embodiment, one of the sensors 81, 82 or both may derive their information indicative of the input amount V1 and the output amount V2 from one or more stations upstream or downstream of the buffer system 1, for example extruder parameters of an upstream extruder or cutting parameters of a downstream cutting station.

The first sensor 81 and the second sensor 82 are configured for sending, transmitting or providing information indicative of the input amount V1 and information indicative of the output amount V2, respectively, in the form of control data D, to the control unit 6.

The control unit 6 is configured for receiving or collecting the control data D and to cause the buffer system 1, based on said control data D, to carry out a method for buffering a length of the strip S between the input side A and the output side B while matching the buffer position P1, P2 to the theoretical length L of the strip S between said input side A and said output side B at any given time. The method will be described hereafter in more detail.

The control unit 6 is preconfigured, programmed, arranged or configured for receiving the control data D from the one or more sensors 81, 82. The control unit 6 is further preconfigured, programmed, arranged or configured to calculate or generate, based on said control data D, a computed value N indicative of the theoretical length L of the strip S in the buffer system 1 between the input side A and the output side B. The computed value N may be the theoretical length L itself, for example expressed as:

N=L

Alternatively, the computed value N may be a parameter that can be directly or indirectly used to determine the theoretical length L. The computed value N may for example also be the effect of a change in the input amount V1 and/or the output amount V2 on the theoretical length L. The movement of the buffer member 2 may be controlled as a direct function of the effect, i.e. when the input amount V1 is higher than the output amount V2, the buffer member 2 is moved in a predetermined ratio to the difference between the amounts V1, V2, for example in a ratio of 1:2 because the cumulative effect ΣE is divided over two instances of the first buffer length section L1.

In particular, the theoretical model M, when executed by the control unit 6, is configured for outputting the computed value N as a function of the control data D.

The control unit 6 is further preconfigured, programmed, arranged or configured to control the buffer drive 5 to position the buffer member 2 at one buffer position P1, P2 from the range of buffer positions P1, P2 based on the computed value N. More in particular, the theoretical model M, when executed by the control unit 6, is further configured for outputting a position value P indicative of said one buffer position P1, P2 from the range of buffer positions P1, P2 that provides the buffer capacity to match the theoretical length L of the strip S. The position value P is transmitted by the control unit 6 to the buffer drive 5 to control the buffer position P1, P2 of the buffer member 2 accordingly.

The position value P may be based on, derived from or equal to the value of the first buffer section length L1. The position value P can be expressed as:

P=L1

Alternatively, the memory unit 7 stores a table T as shown in FIG. 5. The table T may comprise a list of position values P indicative of the range of buffer positions P1, P2 cross-referenced with a list of predetermined values X indicative of the buffer capacity of the buffer system 1 at the respective buffer positions P1, P2. The control unit 6 is configured for selecting one position value P from the list of position values P based on the predetermined value X from the list of predetermined values X that best matches the theoretical length L of the strip S. The position value P is transmitted by the control unit 6 to the buffer drive 5 to control the buffer position P1, P2 of the buffer member 2 accordingly.

The control unit 6 is arranged for executing the theoretical model M in cycles. Preferably, the cycles are repeated at a frequency such that the resulting movement control of the buffer member 2 can be perceived as almost continuous or stepless.

In one particular embodiment the buffer capacity corresponding to the one buffer position P1, P2 is controlled to be smaller than the theoretical length L of the strip S indicated by the computed value N on which said one buffer position P1, P2 is based. Preferably, the buffer capacity is controlled to be smaller than the theoretical length L in a range of zero to two percent of the theoretical length L, and more preferably zero to one percent. In this manner, the strip S can be stretched slightly to prevent slacking of the strip S in the buffer system 1. Preferably, the amount of stretching is kept constant or substantially constant.

The aforementioned steps of the method can be captured in software, a computer-implemented invention, a (non-transitory) computer-readable medium, a computer-readable data carrier or computer program product comprising instructions that, when executed by the control unit 6, cause the buffer system 1 to behave in the aforementioned manner.

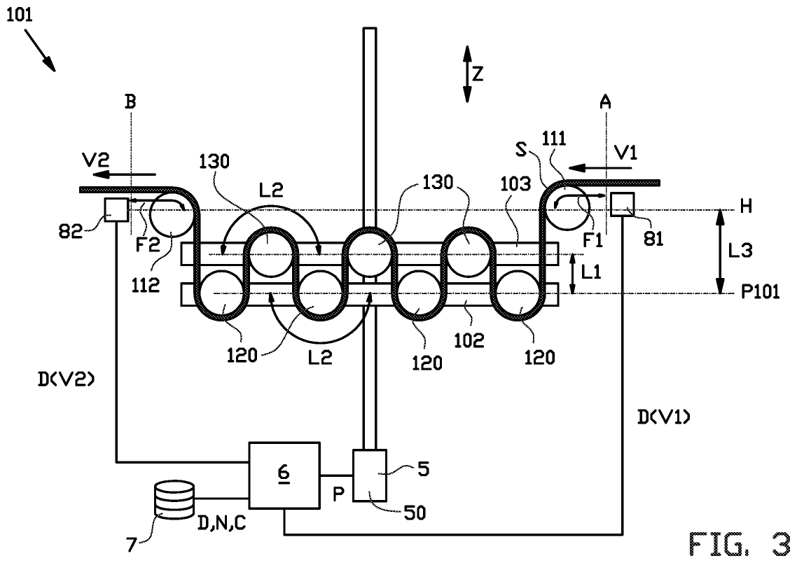

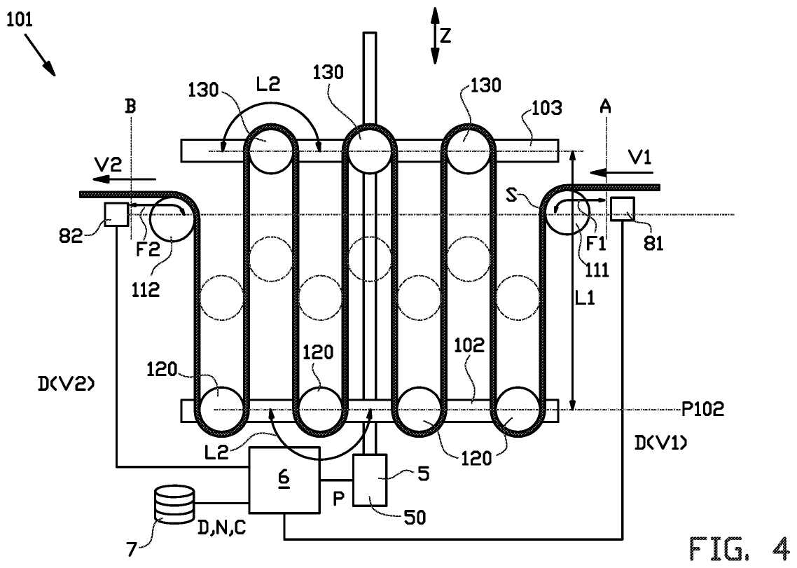

FIGS. 3 and 4 show an alternative buffer system 101 according to a second exemplary embodiment of the invention, that differs from the aforementioned buffer system 1 in that the alternative buffer system 101 comprises a festooner instead of a dancer roller. The festooner is provided with a first holder 102 and a second holder 103 for holding a first group of festooner rollers 120 and a second group of festooner rollers 130. At least one of the holders 102, 103 can be moved towards and away from the other of the holders 102, 103 in the buffer direction Z to vary the buffer capacity of the alternative buffer system 101. In this example, both holders 102, 103 are movable in opposite directions towards and away from each other. The strip S is configured to follow a meandering path through the festooner, alternately passing along a festooner roller 120 of the first group and a festooner roller 130 of the second group.

Like the aforementioned buffer system 1, the alternative buffer system 101 comprises one or more infeed rollers 111 and one or more outfeed rollers 112 that define a fixed input length F1 and a fixed output length F2 at the input side A and the output side B, respectively. Between the one or more infeed rollers 111 and the one or more outfeed rollers 112, it becomes more interesting.

In particular, the strip S meanders along a path with a plurality of first buffer length sections L1, six to be precise, a plurality of second buffer length sections L2, seven to be precise, and two third buffer length sections L3. The length of the first buffer length sections L1 is defined by the distance between the first holder 102 and the second holder 103. The length of the second buffer length sections L2 is again equal to a semicircular arc. The length of the third buffer length sections L3 is defined by the distance between the position of the first holder 102 and a reference height H, in this example the height of the one or more infeed rollers 111 and the one or more outfeed rollers 112.

The formula for the theoretical length L of the strip S thus becomes:

L=F1+(6·L1)+(7·L2)+(2·L3)+F2

The cumulative effect ΣE is divided over six instances of the first buffer length section L1. Therefore, the first buffer length section L1 can be determined as:

$$L 1 = R - ( F 1 + ( 7 \cdot L 2 ) + ( 2 \cdot L 3 ) + F 2 ) + \frac{\sum E}{6}$$

Again, the formulas above are merely provided to illustrate a possible implementation of the theoretical model for the alternative buffer system 101 and is by no means intended to limit the scope of the invention.

The determined first buffer length section L1 can be used to control the position of at least one of the holders 102, 103 or both. If only one of the holders 102, 103 is moved, for example the first holder 102, then the position value P may be directly based on the first buffer length section L1. If both holders 102, 103 are moved, two position values have to be calculated, one for each holder 102, 103, in order to control the buffer positions P1, P2 of the holders 102, 103 accordingly.

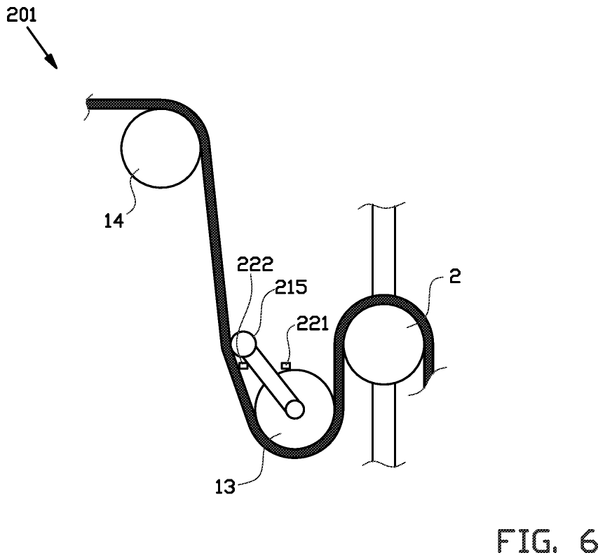

FIG. 6 shows a further alternative buffer system 201 according to a third exemplary embodiment of the invention, which differs from the buffer system 1 according to a first exemplary embodiment of the invention only in that it further comprises a tension sensor 215 for measuring tension in the strip S along the length of the strip S within the further alternative buffer system 201. In this example, the tension sensor 215 is a mechanical finger resting against a section of the strip S at a variable orientation depending on the tension in the strip S. In particular, the finger or the arm is provided with a sensing roller for contacting and/or rolling over the section of the strip S. In this example, the finger is hinged to one of the rollers 12, 13, 14, in particular one of the outfeed rollers 13, 14. Two position sensors 221, 222. The two position sensors 221, 222 are configured for generating signals indicative of the presence or absence of the mechanical finger in two positions or orientations intersecting with the respective positions of the two position sensors 221, 222. The position sensors 221, 222 are electronically, operationally and/or functionally connected to the control unit 6. Alternatively, an encoder may be provided at the hinge point of the tension sensor 215, or the tension sensor 215 itself may be configured for generating a signal directly or indirectly indicative of the tension in the strip S.

In this exemplary embodiment, the first position sensor 221 can detect movement or a position of the mechanical finger indicative of a tension increase in the strip S, whereas the second position sensor 222 can detect movement or a position of the mechanical finger indicative of a tension decrease. The second position sensor 222 may also be positioned such that it is only triggered when the strip S is no longer continuous or has fallen out of the further alternative buffer system 201.

Notwithstanding the positioning of the buffer member 2 in one of the buffer positions P1, P2 based on the computed value N indicative of the theoretical length L of the strip S, the signals indicative of the tension in the strip S can be used to further adjust, correct or finetune the position of the buffer member 2 relative to the one buffer position to which the buffer member 2 is moved based on the computed value N of the theoretical length L. The further adjustment of the position of the buffer member 2 based on the tension may for example be used to cancel out unwanted variations in tension, to prevent the build-up of tension over several feeding cycles or to reduce tension in the strip S prior to or during a subsequent cutting operation. The further adjustment can be performed at the start or end of a feeding stroke of the strip S, i.e. when the strip S is stationary, or at one or more intervals during the feeding of the strip S through the further alternative buffer system 201.

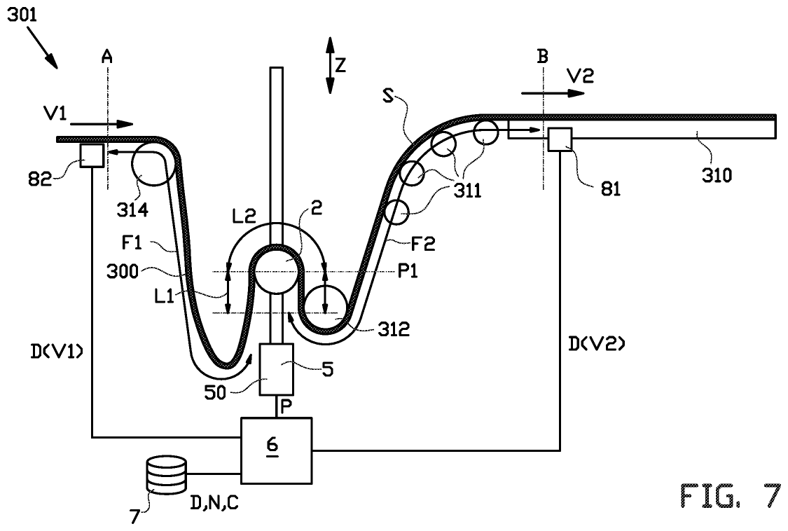

FIG. 7 shows a further alternative buffer system 301 according to a fourth exemplary embodiment of the invention, which differs from the buffer system 1 according to the first exemplary embodiment in that input side A and the output side B have switched sides. Consequently, the strips S is fed through the further alternative buffer system 301 in the opposite direction. Hence, rollers previously termed ‘infeed rollers’ are now outfeed rollers 311, 312, whereas the previously termed ‘outfeed rollers’ are infeed rollers 314. Hence, the first sensor 81 is now located at or near the output side B, whereas the second sensor 82 is now located at or near the input side A. It will be apparent to one skilled in the art that the control of the buffer member 2 based on the computed value N for the theoretical length L of the strip S can still function in substantially the same way.

In this example, the further alternative buffer system 301 further differs from the buffer system 1 in FIG. 1 in that one of the rollers adjacent to the buffer member 2, in this example one of the infeed rollers, is absent. Instead, the further alternative buffer system 301 defines a slacking section 300 for receiving the strip S from the infeed roller 314 at or near the input side A to the buffer member 2 and for feeding said strip S via a free loop to or towards the buffer member 2. This has the technical advantage that any remaining tension in the strip S can be cancelled out or absorbed in the free loop of the strip S in the slacking section 300. The theoretical model M of the further alternative buffer system 301 may be adapted to exclude the infeed length F1 of the strip S in said slacking section 300 or to assume that said infeed length F1 has a fixed value.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### List of Reference Numerals

1 buffer system
10 supply conveyor
11 infeed roller
12 infeed roller
13 outfeed roller
14 outfeed roller
2 buffer member/dancer roller
4 guide
5 buffer drive
50 servo motor
6 control unit
7 memory unit
81 first sensor
82 second sensor
101 alternative buffer system
111 infeed roller
112 outfeed roller
102 first holder/buffer member
120 festooner roller
103 second holder
130 festooner roller
201 further alternative buffer system
215 tension sensor
221 first position sensor
222 second position sensor
300 slacking section
301 further alternative buffer system
310 output conveyor
311 outfeed roller
312 outfeed roller
314 infeed roller
A input side
B output side
D control data
E (cumulative) effect
F1 input length
F2 output length
H input height/output height
L theoretical length
L1 first buffer length section
L2 second buffer length section
L3 third buffer length section
M theoretical model
N computed value
P position value
P1 first buffer position
P2 second buffer position
P101 first buffer position
P102 second buffer position
R reference value
S strip
T table
V1 input amount
V2 output amount
X predetermined value
Z buffer direction

1-35. (canceled)

36. A buffer system for buffering a length of a strip between an input side and an output side, wherein the buffer system comprises a buffer member that is movable in a buffer direction along a range of buffer positions to vary a buffer capacity of the buffer system, a buffer drive for moving the buffer member in said buffer direction and a control unit that is operationally connected to the buffer drive, wherein the control unit is configured for receiving control data having information indicative of an input amount of the strip at the input side and information indicative of an output amount of the strip at the output side, and for generating, based on said control data, a computed value indicative of a theoretical length of the strip in the buffer system between the input side and the output side, wherein the control unit is further configured for controlling the buffer drive to position the buffer member at one buffer position from the range of buffer positions based on the computed value.

37. The buffer system according to claim 36, wherein the buffer system further comprises a memory unit that is operationally connected to the control unit, wherein the memory unit stores a theoretical model of the buffer system, wherein the theoretical model, when executed by the control unit, is configured for outputting the computed value as a function of the control data.

38. The buffer system according to claim 37, wherein the computed value is the theoretical length of the strip.

39. The buffer system according to claim 37, wherein the memory unit is configured for storing a reference value for the theoretical length of the strip, wherein the computed value is an effect of the control data on the reference value.

40. The buffer system according to claim 39, wherein the control unit is arranged for executing the theoretical model in cycles, wherein the reference value is defined at the start of the first cycle and remains the same during the subsequent cycles, wherein the computed value is the cumulative effect of the control data on the reference value after each cycle.

41. The buffer system according to claim 39, wherein the control unit is arranged for executing the theoretical model in cycles, wherein the reference value is defined at the start of the first cycle and wherein for each subsequent cycle the reference value is the sum of the reference value of the previous cycle and the effect of the control data on said reference value.

42. The buffer system according to claim 37, wherein the theoretical model, when executed by the control unit, is further configured for outputting a position value indicative of said one buffer position from the range of buffer positions that provides the buffer capacity to match the theoretical length of the strip, wherein the control unit is configured for controlling the buffer drive to position the buffer member at said one buffer position corresponding to said position value.

43. The buffer system according to claim 37, wherein the memory unit stores a list of position values indicative of the range of buffer positions cross-referenced with a list of predetermined values indicative of the buffer capacity of the buffer system at the respective buffer positions, wherein the control unit is configured for selecting one position value from the list of position values based on the predetermined value from the list of predetermined values that best matches the theoretical length of the strip, wherein the control unit is configured for controlling the buffer drive to position the buffer member at said one buffer position corresponding to said one position value.

44. The buffer system according to claim 36, wherein the buffer capacity corresponding to the one buffer position is smaller than the theoretical length of the strip indicated by the computed value on which said one buffer position is based.

45. The buffer system according to claim 36, wherein the input amount is the distance of travel of the strip at the input side and wherein the output amount is the distance of travel of the strip at the output side.

46. The buffer system according to any one claim 36, wherein the buffer system comprises one or more sensors that are operationally connected to the control unit for providing the information indicative of the input amount and/or the information indicative of the output amount to the control unit.

47. The buffer system according to claim 45, wherein the one or more sensors comprises encoders.

48. The buffer system according to claim 36, wherein the information indicative of the input amount and/or the information indicative of the output amount comprises one or more control parameters originating from one or more stations upstream or downstream of the buffer system.

49. The buffer system according to claim 36, wherein the buffer member is a dancer roller.

50. The buffer system according to claim 36, wherein the buffer system comprises a festooner with a first holder and a second holder for holding a first group of festooner rollers and a second group of festooner rollers, wherein the buffer member is one of the first holder and the second holder.

51. The buffer system according to claim 36, wherein the buffer drive comprises a servo motor.

52. The buffer system according to claim 36, wherein the buffer system further comprises a tension sensor for sensing tension in the strip.

53. The buffer system according to claim 36, wherein the buffer system further comprises an infeed roller for feeding the strip to the buffer member and a slacking section between the infeed roller and the buffer member for receiving a free loop of the strip.

54. A method for buffering a length of a strip between an input side and an output side of a buffer system, wherein the buffer system comprises a buffer member that is movable in a buffer direction along a range of buffer positions to vary a buffer capacity of the buffer system, wherein the method comprises the steps of:
collecting control data having information indicative of an input amount of the strip at the input side and information indicative of an output amount of the strip at the output side;
generating a computed value indicative of a theoretical length of the strip in the buffer system between the input side and the output side based on said control data; and
positioning the buffer member at one buffer position from the range of buffer positions based on the computed value.

55. The method according to claim 54, wherein the method further comprises the steps of:
providing a theoretical model of the buffer system; and
executing the theoretical model;
wherein the theoretical model outputs the computed value as a function of the control data.

56. The method according to claim 55, wherein the computed value is the theoretical length of the strip.

57. The method according to claim 55, wherein the method further comprises the step of:
storing a reference value for the theoretical length of the strip;
wherein the computed value is the effect of the control data on the reference value.

58. The method according to claim 57, wherein the method comprises the steps of:
executing the theoretical model in cycles;
defining the reference value at the start of the first cycle;
wherein the reference value remains the same during the subsequent cycles, wherein the computed value is the cumulative effect of the control data on the reference value after each cycle.

59. The method according to claim 57, wherein the method comprises the steps of:
executing the theoretical model in cycles;
defining the reference value at the start of the first cycle;
wherein for each subsequent cycle the reference value is the sum of the reference value of the previous cycle and the effect of the control data on said reference value.

60. The method according to claim 55, wherein the theoretical model, when executed, outputs a position value indicative of said one buffer position from the range of buffer positions that provides the buffer capacity to match the theoretical length of the strip, wherein the method comprises the step of positioning the buffer member at said one buffer position corresponding to said position value.

61. The method according to claim 55, wherein the method further comprises the steps of:
storing a list of position values indicative of the range of buffer positions cross-referenced with a list of predetermined values indicative of the buffer capacity of the buffer system at the respective buffer positions; and
selecting one position value from the list of position values based on the predetermined value from the list of predetermined values that best matches the theoretical length of the strip;
wherein the buffer member is positioned at said one buffer position corresponding to said one position value.

62. The method according to claim 54, wherein the buffer capacity corresponding to the one buffer position is smaller than the theoretical length of the strip indicated by the computed value on which said one buffer position is based.

63. The method according to claim 54, wherein the input amount is the distance of travel of the strip at the input side and wherein the output amount is the distance of travel of the strip at the output side.

64. The method according to claim 54, wherein the buffer system comprises one or more sensors for providing the information indicative of the input amount and/or the information indicative of the output amount.

65. The method according to claim 54, wherein the information indicative of the input amount and/or the information indicative of the output amount comprises one or more control parameters originating from one or more stations upstream or downstream of the buffer system.

66. The method according to claim 54, wherein the buffer member is a dancer roller.

67. The method according to claim 54, wherein the buffer system comprises a festooner with a first holder and a second holder for holding a first group of festooner rollers and a second group of festooner rollers, wherein the buffer member is one of the first holder and the second holder.

68. The method according to claim 54, wherein the method further comprises the steps of:
sensing tension in the strip; and
adjusting the position of the buffer member relative to said one buffer position from the range of buffer positions based on the tension in the strip.

69. The method according to claim 54, wherein the buffer system further comprises an infeed roller for feeding the strip to the buffer member and a slacking section between the infeed roller and the buffer member, wherein the method further comprises the step of receiving a free loop of the strip in said slacking section.

70. A computer program product comprising instructions that, when executed by a processor, cause the buffer system to perform the steps of the method according to claim 54.
